(19) United States
(12) Patent Application Publication
(10) Pub. No.: US 2020/0249035 A1
(43) Pub. Date: Aug. 6, 2020

(54) Automatic Target Selection for Worksite Spotting

(71) Applicant: Caterpillar Inc., Deerfield, IL (US)

(72) Inventor: David Gitz, Peoria, IL (US)

(73) Assignee: Caterpillar Inc., Deerfield, IL (US)

(21) Appl. No.: 16/264,862

(22) Filed: Feb. 1, 2019

(51) Int. Cl. G01C 21/34; G01C 21/36; B60K 35/00

(52) U.S. Cl. CPC G01C 21/3407; G01C 21/3614; G01C 21/3617; B60P 1/04; B60K 2350/106; B60K 2350/1008; B60K 35/00

(57) ABSTRACT

An automatic target selection system and method for worksite load spotting is presented. The system includes a work machine configured with a receptacle for receiving a load. A position detection unit, on-board the work machine, generates a signal associated with a current position and heading of the work machine. A display unit, on-board the work machine, displays a user interface which includes a plurality of operator-selectable spotting locations. A navigation controller is configured to receive the signal of the current position and heading of the work machine, generate a list of spotting locations associated with one or more loading machines on a worksite; and determine a target score for each spotting location based on a Cartesian distance, path distance, and a selection history. The navigation controller then displays an organized catalog of the spotting locations based on the corresponding target score.

### TECHNICAL FIELD

The present disclosure generally relates worksite machine loading and, more particularly, to a method and system for automatic target selection for maneuvering haulage machines on a worksite.

### BACKGROUND

At worksites, such as excavation, surface mines, construction, and agricultural sites, worksite machines are typically relied up on to transport loads of from one location to another within the worksite. A transportation machine is docked or positioned in a particular target location to ensure the proper loading of material. A loading machine operator typically indicates to a worksite machine operator the requested loading position by moving a loading implement approximately over the loading position. The transportation machine operator manually judges the position of the loading implement in order to receive the load relying on eyesight or tire tracks. For example, one or more loading machines such as hydraulic excavators, wheeled or tracked loaders, electric rope shovels, etc. may be deployed at a mine site. A plurality of transportation machines, such as a fleet of haul trucks, may move to the area along one or more haul roads. The haul trucks queue up and sequentially move into position to receive a load from the excavating or mining machine.

Generally, the loading machine remains at the same location, while repositioning itself to load a truck that is in position to receive a load. Parking the haul truck in the proper spot next to the loading machine is referred to as “spotting.” Accurate spotting is essential for avoiding collisions between the loading machine and the haul truck, avoiding spilled material from the loading machine, and reducing wasted time and fuel due to improper spotting or repositioning the loading machine implement. Haul trucks are characterized by limited maneuverability, relatively slow acceleration and deceleration, and poor sight lines on all sides of the truck. Due to the difficult nature of spotting a haul truck, drivers must maintain focus and must be presented with relevant information in an efficient and rapid manner.

One truck loading system, U.S. Pat. No. 8,583,361 B2, discloses a navigation aid which assists an operator of the vehicle to navigate to a particular target destination. The navigation aid is configured identify a listing of potential target destinations are organized based only upon a proximity to the vehicle, with target that are over a threshold distance away being filtered out.

The disclosed method and system for positioning a truck for loading is directed to overcoming one or more of the problems set forth above.

### SUMMARY OF THE DISCLOSURE

In accordance with one aspect of the disclosure, an automated target selection system for worksite spotting locations is provided. The system comprises a work machine configured with a receptacle for receiving a load from a loading machine. The work machine includes an on-board position detection unit having at least one sensor for generating a signal of a current position and heading of the work machine. The system includes an on-board display unit for displaying a user interface which includes a plurality of operator-selectable spotting locations. An on-board navigation controller is communicably coupled to the position detection unit and the display unit. The navigation controller is configured to receive the signal of the current position and heading from the position detection unit and generates a list of of spotting locations associated with one or more loading machines on a worksite. The navigation controller then determines a Cartesian distance and path distance for each spotting location based on the current position and head of the work machine. The navigation controller determines a selection history for each spotting location based on an operator input history of the user interface. Then, the navigation controller calculates a target score for each spotting location based on the corresponding Cartesian distance, path distance, and selection history and displays an organized catalog of the spotting locations in the user interface based on the corresponding target score.

In accordance with another aspect of the disclosure, a method for automated target selection for worksite spotting locations is provided. A method for automated target selection system for worksite spotting locations. The method comprises receiving a signal of a current position and heading from a position detection unit of a work machine. A list of spotting locations associated with one or more loading machines on a worksite is generated. A Cartesian distance and a patch distance to each spotting location is determined based on the signal of the current position and heading of the work machine. A selection history for each spotting location is determined based on an operator input history of a user interface. A target score for each spotting location is calculated based on the corresponding Cartesian distance, path distance, and selection history and then an organized catalog of the spotting locations is displayed in the user interface based on the corresponding target score.

In accordance with a further aspect of the disclosure, a haul machine is provided. The haul machine comprises a position detection unit having at least one sensor for generating a signal associated with the current position and heading of the work machine. The haul machine includes a display unit for displaying a user interface which includes a plurality of operator-selectable graphical elements each associated with a spotting location. A navigation controller is configured to receive the signal of the current position and heading from the position detection unit. The navigation controller also generates a list of spotting locations associated with one or more loading machines on a worksite and determines a Cartesian distance and a patch distance to each spotting location based on the signal of the current position and heading of the work machine. The navigation controller determines a selection history for each spotting location based on an operator input history of the user interface. Based on the corresponding Cartesian distance, path distance, and selection history, the navigation controller calculates a target score for each spotting location and displays an organized catalog of the spotting locations in the user interface based on the corresponding target score.

### BRIEF DESCRIPTION OF THE DRAWINGS

FIG. 1 is a diagrammatic side view of a hauling machine in accordance with an embodiment of the present disclosure;

FIG. 2 is a diagrammatic view of a worksite in accordance with an embodiment of the present disclosure;

FIG. 3 is a is a schematic diagram illustrating an exemplary automatic target selection system, in accordance with an embodiment of the present disclosure;

FIGS. 4-6 are a schematic diagram illustrating an exemplary graphical user interface of an automatic target selection system, in accordance with an embodiment of the present disclosure; and

FIG. 7 is a flow chart of a method of operation of the automatic target selection system.

### DETAILED DESCRIPTION

Aspects of the disclosure will now be described in detail with reference to the drawings, wherein like reference numbers refer to like elements throughout, unless specified otherwise.

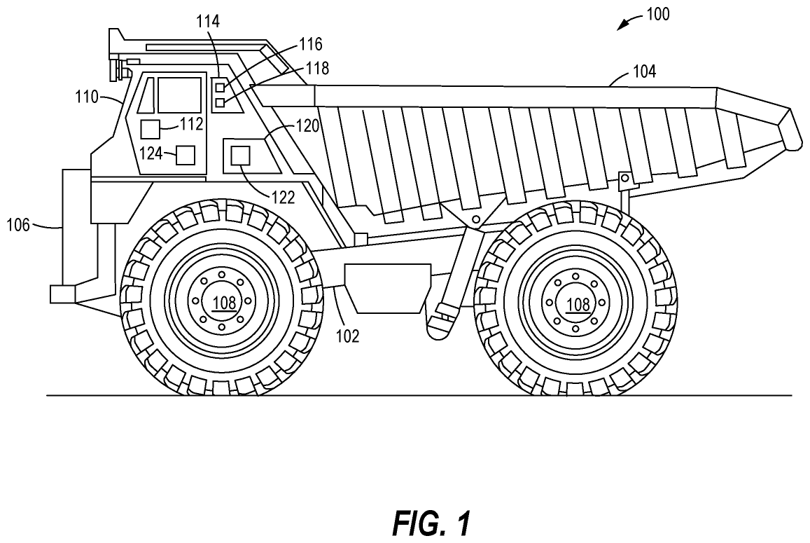

Referring to FIG. 1, a schematic view of a work machine 100 for performing a variety of predetermined tasks at a worksite is depicted. According to an exemplary embodiment of the present disclosure, the work machine 100 is a haul truck deployed on the worksite. It should be appreciated that the work machine 100 may include other industrial work machines such as, but not limited to, large mining trucks, articulated trucks, off-highway trucks, and the like.

The worksite may include, for example, a mine site, a landfill, a quarry, a construction site, or any other type of worksite. The predetermined tasks may be associated with altering the current terrain of the worksite. For example, a clearing operation, a hauling operation, a digging operation, a loading operation, or any other type of worksite operation that functions to alter the current topography of the worksite.

The work machine 100 may include a frame and/or chassis 102. A dump body or dump receptacle 104 is pivotably mounted to the chassis 102 to enable a tilting movement of the dump receptacle 104 relative to the chassis 102. The dump receptacle 104 can be used for transportation of material such as sand, gravel, stones, soil, excavated material, and the like from one location to another on the worksite to aid in the function to alter the current topography of the worksite.

The work machine 100 includes a powertrain or a drivetrain 106 for the production and transmission of motive power. The powertrain 106 may include an engine such as an internal combustion engine, a gas turbine, a hybrid engine, or the like. The powertrain 106 may include a motor connected to a power source like batteries, fuel cell, generator, or any other power source known in the art to power a motor. The powertrain 106 may further include a torque converter, geared transmission, drive shafts, differentials, or other known drive links for transmission of motive power from the engine to ground engaging members 108. The ground engaging members 108, such as wheels or tracks, are mounted to the chassis 102 by a suspension system (not shown) which may include suspension springs, beams, hydraulic cylinders, axles, and the like for the purpose of mobility of the work machine 100 relative to the worksite terrain. An operator cabin 110 may be provided on the work machine 100 which houses the various operator input devices and controls of such as, but not limited to, a joystick, keyboard, steering wheel, pedal, lever, button, switch, display device, touchscreen, etc. for the control of the work machine 100. In an exemplary embodiment, the operator cab 110 includes a touchscreen display device 112 configured to display a graphical user interface which can receive an operator touch input associated with displayed operator-selectable graphical elements.

The work machine 100 may be equipped with an on-board position detection unit (PDU) 114 which is configured to determine the current location and heading of the work machine 100 and generate a signal indicative thereof. The PDU 114 includes at least one or a plurality of various position sensors 116 to determine current positional information associated with the work machine 100. The position sensor 116 could embody, for example, a Global Positioning Satellite system (GPS or GNSS) device, an inertial measurement unit (IMU), a local tracking system, a laser range finding device, a sonic range finding device, an odometric or dead-reckoning device, or any other known locating device that receives or determines current positional information. The PDU 114 includes at least one or a plurality of various orientation sensors 118 to determine current orientational information associated with the work machine 100. The orientation sensor 118 could embody, for example, a laser-level sensor, a tilt sensor, an inclinometer, a radio direction finder, a gyrocompass, a fluxgate compass, or another device to facilitate heading and/or inclination detection. The PDU 114 is configured to convey or transmit a position signal indicative of the current location and orientation of the work machine 100. It is contemplated that the position signal can also be directed to a display device with a worksite user interface for display of the work machine 100 current location and orientation on an electronic representation of the worksite.

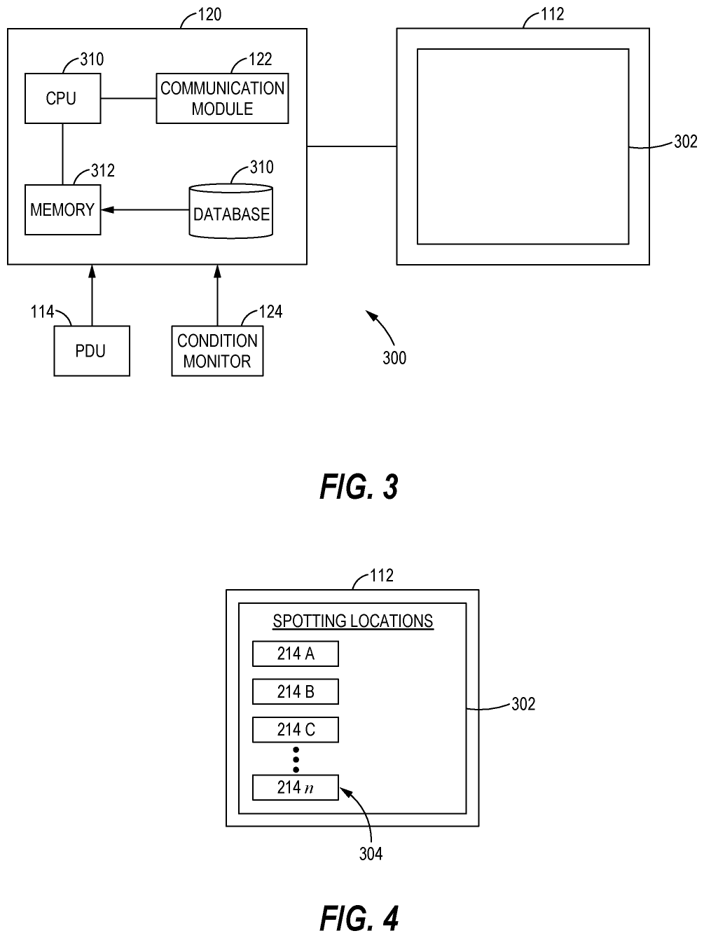

The work machine may be equipped with an on-board navigation controller 120 which is configured to generate a spotting user interface for display on the display unit 112 housed in the operator cab 110, which will be discussed in greater detail with reference to FIG. 3. The navigation controller 120 generates a user interface which includes a plurality of operator-selectable spotting locations. The spotting locations are can be generated as an ordered list of spotting locations which are ordered according to according to a target score determined for each spotting location. It should also be appreciated that the spotting locations can be generated as a plurality of waypoints overlaid upon an electronic terrain map of the worksite that is generated within the user interface. The corresponding target score can be overlaid upon the terrain map adjacent to the corresponding waypoint or can augment the waypoint representation with a color, marker, or size indicator related to the target score associated with the corresponding spotting location.

To determine the target score, the navigation controller 120 can correlate any number of navigational factors to determine the target score for each spotting location. Navigational factors may include a distance such as a Cartesian distance, a Euclidean distance, a path distance, or any other known distance measurement. The navigation controller 120 may also correlate historical data to calculate the target score. For example, the number of times an operator selects the spotting location via the user interface, i.e. a selection history, the number of times the operator visits the spotting location with the work machine 100, i.e. a visitation history, or the number of times the operator travels within a vicinity of a spotting location, i.e. a proximity history. The navigation controller 120 may also weight the various navigational factors to determine the target based on a weighted sum function. It should be appreciated that other statistical models and functions are also contemplated to determine the target score for each spotting location.

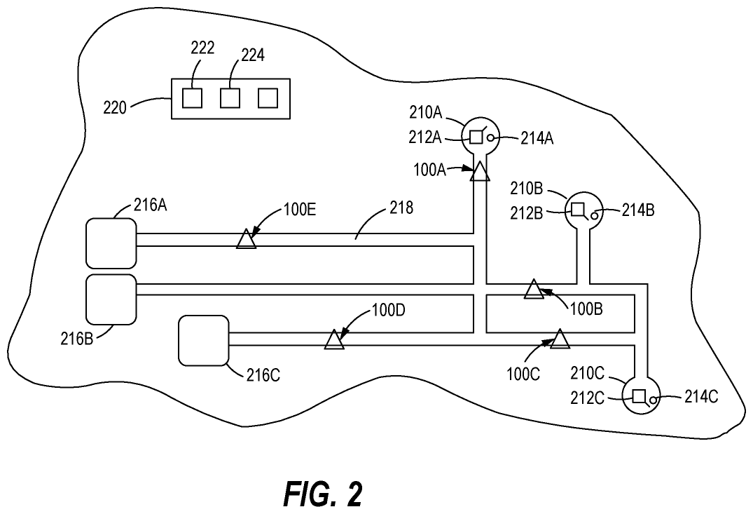

The navigation controller 120 includes a communication module 122, such as a transceiver, which may include hardware and/or software that enables sending data messages or signals between the work machine 100 and an off-board worksite controller, which will be discussed in further detail with reference to FIG. 2. In an exemplary embodiment, the communication module 122 generates a wireless communication link with the worksite controller to transmit and/or receive data messages there between, such as, but not limited to a three-dimensional (3D) electronic terrain map as well as an updated list of current locations of designated operational locations and various machines deployed throughout the worksite.

The communication module 122 is also configured to receive vehicle condition data retrieved from a vehicle condition monitor 124. The vehicle condition data may include the current gear selection, payload, parking brake status, or other information identifying a condition of the vehicle that can be useful to determine a capability of the vehicle to execute a particular maneuver or traverse a particular travel path. Additional information may include, for example, engine size, fuel reserves, tire or wheel types (indicating whether the vehicle is capable of traveling over particular types of terrain), maintenance or repair status (indicating, for example, whether the vehicle should avoid long distance maneuvers). The vehicle condition data may also describe the vehicle's performance characteristics such as turning radius, maximum speed, optimum speed for fuel efficient operation, maximum slope that the vehicle can climb, weight of the vehicle, or other information that is used to determine whether the vehicle can proceed along a particular travel path in a worksite environment.

As shown in FIG. 2, a worksite 200 is a complex network of multiple locations designated for particular worksite tasks as well as a fleet of various work machines deployed and traversing about the worksite. For example, the worksite 200 may include one or more locations designated as loading locations 210A, 210B, 210C at which a mobile loading machine 212A, 212B, 212C operates to fill work machines 100A, 100B, 100C, 110D, 110E such as a haul machine as depicted in the exemplary embodiment. Each loading location includes 210A-210C includes a designated spotting location 214A, 214B, 214C where a work machine 210A-210C is accurately positioned to receive material from the loading machine 212A-212C for transportation to a designated dump location 216A, 216B, 216C at which the work machine 100A-100E discards their payload. The work machines 100A-100E may follow any number of predetermined travel paths 218 between the various loading locations 210A-210C and dump locations 216A-216C. As the various work machines 100A-100E and loading machines 212A-212C work in concert with other worksite machines for the purpose of altering the terrain of the worksite 200, the topology of the terrain changes and, in response, the position of the various loading locations 210A-210C, dump locations 216A-216C, and travel paths 218 there between change as well. As loading locations 210A-210C change, the location of mobile loading machines 212A-212C and their corresponding spotting locations 214A-214C change too.

The current 3D terrain topology is monitored and updated by an off-board worksite controller 220 as a 3D electronic terrain map stored as data in a database 222. The worksite controller 220 includes a communication module 224 configured to create a wireless communication link with the work machines 100A-100E and loading machines 212A-212C. The database 222 also includes a list of the loading sites 210A-210C and spotting locations 214A-214C that correspond with each loading machines 212A-212C. The 3D terrain topology along with the list of loading sites 210A-210C and spotting sites 214A-214C may be updated on a real-time or periodic basis according to the worksite requirements.

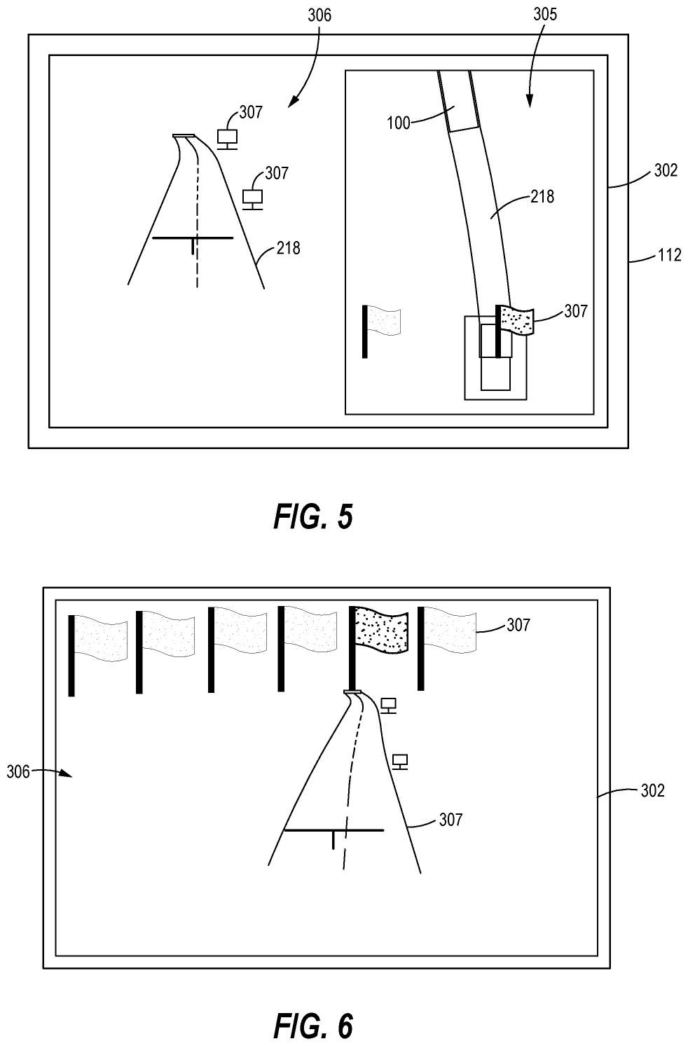

With reference to FIGS. 3-5, the work machines 100A-100E may include an automated target selection system (ATSS) 300. The ATSS 300 includes at least the PDU 114, navigation controller 120, and display unit 112. The ATSS 300 is configured to provide a graphical user interface 302 which is displayed on the display unit 112 to convey the spotting locations 214A-214C to an operator situated in the cab 110 of any one of the work machines 100A-100E. The spotting locations 214A-214C are organized or ordered in a catalog according to the target score associated with each spotting location. In one embodiment, as shown in FIG. 4, the graphical user interface 302 catalogs spotting locations 214A-214C according to an ordered list 304 that presents a list of operator-selectable buttons in which each button is associated with a single spotting location 214A-214C. While only a few spotting locations 214A-214C are illustrated in FIG. 2, it should be appreciated that a worksite may have dozens of loading machines each with one or more spotting locations.

Typically, a generic or indistinct list of spotting locations is provided to a work machine operator. The operator has to manually scroll or sift through the list to find the best spotting location for the specific work machine. This process of trying to select a spotting location is time consuming and distracting to a work machine operator who must maintain a high level of focus and concentration to operate the work machine. The ATSS 300 provides an ordered list 304 of spotting locations 214A-214C to the operator in order to reduce the amount of information conveyed to the operator of the work machine 100A-100E such that the operator can quickly and efficiently select a spotting location 214A-214C. The order in which the spotting locations 214A-214C is presented to the operator via the user interface 302 is determined based on a target score determined by the navigation controller 120.

In another embodiment, as shown in FIGS. 5 and 6, the ATSS 300 provides a graphical user interface 302 that displays an ordered or organized catalog of spotting locations 214A-214C according to or as a navigational map. The navigational map may include a number of types of maps such as top-down map 305, a perspective map 306, or a combination thereof. The maps 305,306 include the travel paths 218 available to the operator as well as indicators 307 which indicate the various spotting locations 214A-214C. Similar to the ordered list 304, the indicators 307 are labeled or organized according to the corresponding target score. For example, spotting locations 214A-214C with a target score that is greater than a predetermined threshold can be labeled green, target score below the threshold can be labeled yellow, and spotting locations unavailable to the work machine 100A-100E can be labeled in red or not displayed at all. The indicators 307 are operator-selectable spotting graphical elements such as buttons. The navigational map 305, 306 can also include terrain related information such as grades, hills, obstacles, and the like.

Returning to FIG. 3, the navigation controller 120 is configured to record, store, index, process, and/or communicate various operational aspects of the worksite 200 and the work machine 100A-100E, such as the target score for each spotting location 214A-214C. The navigational controller 120 may include components such as a central processing unit 310, memory 312, one or more data storage devices, or another other component that may be used to run computer executable instructions that are stored to memory 312. It should be appreciated that various computer executable instructions, applications, computer program products, or other aspects that are generally described as stored to memory can also be stored on or read from various computer readable media such as, but not limited to, as computer chips and secondary storage devices, including hard disks, floppy disks, optical media, CD-ROM, or other forms of RAM or ROM.

The navigation controller 120 includes a communication module 122 for sending and receiving data signals with the worksite controller 220 as well as other work machines 100A-110E and loading machines 212A-212C. The navigation controller 120 can receive the 3D electronic terrain map from the worksite controller 220. The navigation controller 120 can also receive a list of the current locations of loading locations 210A-210C, loading machines 212A-212C, spotting locations 214A-214C, work machines 100A-100E, and any other designate site or work machine deployed on the worksite 200. Alternatively, the navigation controller 120 can receive individual coordinates and generate the corresponding list. The navigation controller can store the 3D electronic terrain map and the list of current locations to a database 314. As previously stated, the navigation controller can receive an updated terrain map and list of current coordinates in real-time or periodically as required.

The navigation controller 120 is communicably coupled to the PDU 114 to receive a signal therefrom which includes data indicative of the current position and heading of the corresponding work machine 100A-100E as deployed on the worksite 200. The navigation controller 120 can also store the current position and heading data in database 314. The navigation controller 120 is also communicably coupled to the vehicle condition monitor 124 to receive a signal therefrom which includes data indicative of the current condition or state of the work machine 100A-100E. Similarly, the navigation controller 120 can store the current vehicle condition data in database 314.

The navigation controller 120 is configured to determine or calculate a target score for each spotting location 214A-214C based on correlation between at least one or a plurality of navigation factors, historical factors, vehicle condition factors, or any other factor which may aid in automated target selection for spotting locations. Navigational factors may include a distance such as a Cartesian distance, a Euclidean distance, a path distance, or any other known distance measurement. Historical factors may include the number of times an operator selects the spotting location via the user interface, i.e. a selection history, the number of times the operator visits the spotting location with the work machine 100, i.e. visitation history, or the number of times the operator travels within a vicinity of a spotting location, i.e. a proximity history. Vehicle condition factors may include, as previously stated, the work machine's 100A-100E performance characteristics such as turning radius, maximum speed, optimum speed for fuel efficient operation, maximum slope that the vehicle can climb, weight of the vehicle, maximum load capacity, maximum weight capacity, type of ground engage members, or other information that is used to determine whether the vehicle can proceed along a particular travel path.

The navigation controller 120 correlates the navigational factors to calculate the target score based on a weighted sum function of the navigational factors. In an exemplary embodiment, the navigation controller 120 determines the target score for a corresponding spotting location 214A-214C based on a weighted sum of the Cartesian distance, path distance, and selection history of that corresponding spotting location 214A-214C. The navigation controller 120 determines the Cartesian distance based on the current coordinates of the corresponding spotting location 214A-214C stored in the database 310 and the current position and heading of the work machine 100A-100E which is also stored in database 310.

The path distance is determined based on the current coordinates of the corresponding spotting location 214A-214C, the current position and heading of the work machine 100A-100E, and the current 3D terrain map which are all also stored in database 310. The navigation controller 120 may also determine the path distance based on the vehicle condition factors. The performance characteristics of the vehicle, such as machine dimensions, turning radius, payload capacity, tractive capacity, braking capacity, power, and the like, can be stored as a work machine profile which can be generated by the condition monitor 124. The navigational controller can receive the work machine profile from the condition monitor 124 for storage in the database 310. As previously mentioned, successfully positioning a work machine 100A-100E on a spotting location 214A-214C may require complex maneuvers that certain work machines cannot achieve based on machine's performance characteristics. Performance characteristics can vary from machine to machine which can limit which travel paths 216 it can traverse along with which loading locations 210A-210C or dump locations 216A-216C they can visit. To reduce the amount information presented to the operator, the navigation controller 120 can filter spotting locations 214A-214C based on the work machine profile and only display the spotting locations 214A-214C that the corresponding work machine 100A-100E is capable of visiting based on the performance characteristics. The navigation controller 120 can filter spotting locations 214A-214C by only calculating travel paths 218 for which the work machine 100A-100E can successfully traverse. The navigation controller can determine the path distance based on a path planning method such as a clothoid curve fitting method which uses clothoid curve segments to model the actual path the work machine 100A-100E is to navigate. The path distance may also be calculated to avoid certain areas and/or obstacles that may be located between the work machines 100A-100E current position and the corresponding spotting location 214A-214C.

The selection history is determined by the number of times an operator selects the spotting location via the user interface. The user interface 302 is configured to receive an operator input, store an input history of the operator input to the database 310, and correlate the input history with the ordered list 304 of operator-selectable spotting locations. The selection history is determined based on the correlation between input history and the operator-selectable buttons which are each associated with a single spotting location 214A-214C. The navigation controller 120 stores the selection history for each spotting location 214A-214C to the database 310. In this manner, the more often an operator selects a specific spotting location 214A-214C the greater the corresponding target score is for that spotting location 214A-214C.

The navigation controller 120 then determines the target score for each spotting location 214A-214C based on a weight sum of the corresponding Cartesian distance, path distance, and selection history and then stores the target score in database 310. When the operator invokes the ATSS 300 via the user interface 302, the spotting locations 214A-214C are automatically presented to the operator as the ordered list 304 independent of any further intervention. The spotting locations 214A-214C are ordered according to the target score. For example, the spotting location 214A-214C with the highest target score can be displayed first in the ordered list 304. In the embodiment where the spotting locations 214A-214C are presented overlaid on a visual representation of the terrain map, the spotting locations 214A-214C can be highlighted according to their target score. For example, spotting locations 214A-214C with higher target scores can be presented more prominently according to an indicator size, shape, and/or color.

As previously mentioned, in the exemplary embodiment, the display unit 112 is a touchscreen monitor. The operator invokes the ATSS 300 by interacting with the user interface 304 displayed on the touchscreen monitor 112. The ATSS 300 will display the ordered list of spotting locations 214A-214C according their corresponding target score. Spotting locations 214A-214C in which a path distance cannot be calculated due to performance characteristics are not displayed because a target score is not available and thus are filtered from the ordered list.

### INDUSTRIAL APPLICABILITY

In general, the automatic target selection system 300 of the present disclosure can find applicability in in various industrial applications such as but not limited to work machines 100 such as those used throughout many industries, including but not limited to, earth moving, excavation, mining, agricultural, marine, construction, power generation, and other such industries. Current operator display systems do not automatically provide an ordered list of spotting locations to aid an operator.

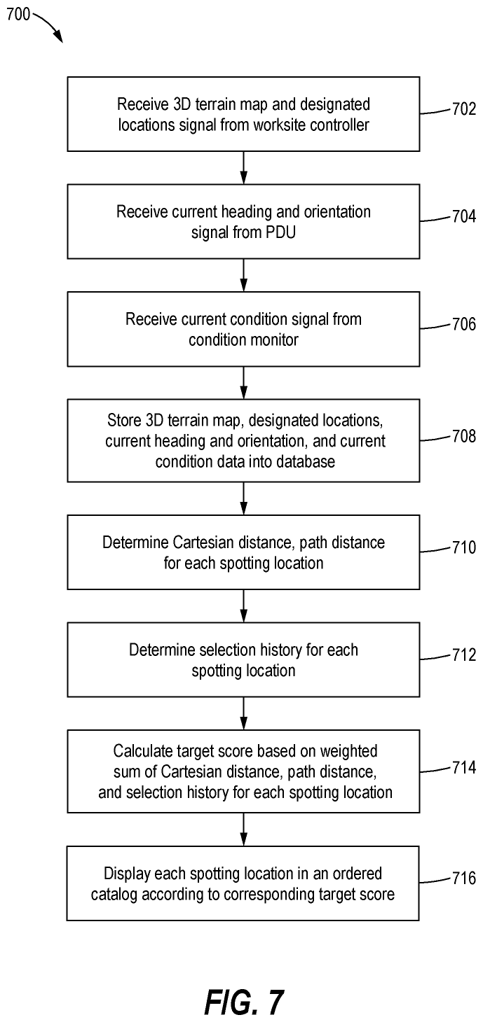

The present disclosure provides an ATSS 300 which automatically provides an ordered list of spotting locations with minimal intervention by the work machine operator. With reference to the flow chart of FIG. 7, a method 700 for automatic target selection is presented according to the present disclosure. At step 702, the navigation controller 120 receives data in the form of a signal which includes the 3D electronic terrain map as well as the current locations (e.g. coordinates) of designated areas, such as loading locations 210A-210C, loading machines 212A-212C, spotting locations 214A-214C, dump locations 216A-216C, and work machines 100A-100E, from the worksite controller 220. At steps 704 and 706, respectively, the navigation controller 120 receives data in the form of a signal associated with the current heading and orientation of the work machine 100 from the position detection unit 114 and associated with the current condition from the condition monitor 124. As the navigation controller receives the data signals, either in real-time or periodically, the data is stored and/or updated in the database 310, step 708. When the operator invokes the ATSS 300 via the user interface 302 by, for example, interacting with a graphical touchscreen element, the navigation controller 120 determines the Cartesian distance and path distance for each spotting location 214A-214C based on the current work machine 100 location and heading, step 710. The navigation controller 120 also determines the selection history for each spotting location 214A-214C, step 712. The navigation controller 120 calculates a target score for each spotting location based on a weighted sum of the Cartesian distance, path distance, and selection history for each spotting location, step 714. Finally, the navigation controller displays each spotting location in an ordered or organized catalog based on their corresponding target score on the user interface 304, step 716.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein is merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

What is claimed is:

1. An automated target selection system for worksite spotting locations, the system comprising:
a work machine configured with a receptacle for receiving a load from a loading machine;
a position detection unit having at least one sensor, on-board the work machine, for generating a signal of a current position and heading of the work machine;
a display unit, on-board the work machine, for displaying a user interface including a plurality of operator-selectable spotting locations;
a navigation controller, on-board the work machine, communicably coupled to the position detection unit and the display unit, the navigation controller configured to:
receive the signal of the current position and heading from the position detection unit;
generate a list of spotting locations associated with one or more loading machines on a worksite;
determine a Cartesian distance and a patch distance to each spotting location based on the signal of the current position and heading of the work machine;
determine a selection history for each spotting location based on an operator input history of the user interface;
calculate a target score for each spotting location based on the corresponding Cartesian distance, path distance, and selection history; and
displaying an organized catalog of the spotting locations in the user interface based on the corresponding target score.

2. The system of claim 1, wherein the target score is calculated based on a weighted combination of the Cartesian distance, path distance, and selection history.

3. The system of claim 1, wherein the navigation controller is further configured to:
receive an electronic terrain map of the worksite;
generate a travel path to each spotting location based on the electronic terrain map and the current position and heading of the work machine; and
calculate the path distance based on the travel path.

4. The system of claim 3, wherein the travel path is generated based on one or more clothoid curve segments.

5. The system of claim 1, wherein the user interface is configured to receive an operator input, store an input history of the operator input, and correlate the input history with the operator-selectable spotting locations to determine the operator input history.

6. The system according to claim 1, wherein the navigation controller generates the list of spotting locations based on a signal received from a source external to the worksite machine, signal including a plurality of spotting locations each associated with at least one loading machine.

7. The system according to claim 1, wherein the navigation controller is further configured to receive a work machine profile including at least one of work machine dimension, turning radius, machine work output capability, receptacle dimensions, payload capacity, tractive capacity, and braking capacity.

8. The system according to claim 7, wherein the target score is calculated based on the work machine profile.

9. The system according to claim 7, wherein the navigation controller filters spotting locations in accordance with the work machine profile.

10. A method for automated target selection system for worksite spotting locations, the method comprising:
receiving a signal of a current position and heading from a position detection unit of a work machine;
generating a list of spotting locations associated with one or more loading machines on a worksite;
determining a Cartesian distance and a patch distance to each spotting location based on the signal of the current position and heading of the work machine;
determining a selection history for each spotting location based on an operator input history of a user interface;
calculating a target score for each spotting location based on the corresponding Cartesian distance, path distance, and selection history; and
displaying an organized catalog of the spotting locations in the user interface based on the corresponding target score.

11. The method according to claim 10, wherein the target score is calculated based on a weighted combination of the Cartesian distance, path distance, and selection history.

12. The method according to claim 10, the method further including:
receiving an electronic terrain map of the worksite;
generating a travel path to each spotting location based on the electronic terrain map and the current position and heading of the work machine; and
calculating the path distance based on the travel path.

13. The method according to claim 10, the method further including:
receiving, from an external source, a signal including a plurality of spotting locations each associated with at least one loading machine.

14. The method according to claim 10, the method further including:
receiving an operator input at the user interface;
storing an input history of the operator input; and
correlating the input history with operator-selectable spotting locations to determine the operator input history.

15. The method according to claim 10, the method further including:
receive a work machine profile including at least one of work machine dimension, turning radius, machine work output capability, receptacle dimensions, payload capacity, tractive capacity, and braking capacity; and
calculating the target score based on the work machine profile.

16. The method according to claim 14, the method further including filtering the spotting locations according to the work machine profile.

17. A haul machine comprising:
a position detection unit having at least one sensor for generating a signal of a current position and heading of the work machine;
a display unit for displaying a user interface including a plurality of operator-selectable graphical elements each associated with a spotting location;
a navigation controller configured to:
receive the signal of the current position and heading from the position detection unit;
generate a list of spotting locations associated with one or more loading machines on a worksite;
determine a Cartesian distance and a patch distance to each spotting location based on the signal of the current position and heading of the work machine;
determine a selection history for each spotting location based on an operator input history of the user interface;
calculate a target score for each spotting location based on the corresponding Cartesian distance, path distance, and selection history; and
displaying an organized catalog of the spotting locations in the user interface based on the corresponding target score.

18. The haul machine of claim 17, wherein the target score is calculated based on a weighted combination of the Cartesian distance, path distance, and selection history.

19. The haul machine of claim 17, wherein the navigation controller is further configured to:
receive an electronic terrain map of the worksite;
generate a travel path to each spotting location based on the electronic terrain map and the current position and heading of the work machine; and
calculate the path distance based on the travel path.

20. The haul machine of claim 17, wherein the user interface is configured to receive an operator input, store an input history of the operator input, and correlate the input history with the operator-selectable spotting locations to determine the operator input history.
